(19) United States
(12) Patent Application Publication
(10) Pub. No.: US 2025/0204310 A1
(43) Pub. Date: Jun. 26, 2025

(54) WALK-BEHIND OUTDOOR POWER MACHINE

(71) Applicant: Greenworks (Jiangsu) Co., Ltd, Changzhou (CN)

(72) Inventors: Nicholas Suchoza, Mooresville, NC (US); David Chreene, Mooresville, NC (US); Bing Tian, Changzhou (CN); Qunli Wei, Changzhou (CN); Ryan Murphy, Mooresville, NC (US); Yin Chen, Changzhou (CN); Jianlong Chen, Changzhou (CN); Ernest Spangler, Mooresville, NC (US); Xiaohui Huo, Changzhou (CN); Troy Efird, Mooresville, NC (US); Ola Agné, Malmo (SE)

(21) Appl. No.: 19/080,792

(22) Filed: Mar. 15, 2025

Related U.S. Application Data
(63) Continuation of application No. PCT/CN2022/119232, filed on Sep. 16, 2022.

(51) Int. Cl. A01D 34/69; A01D 34/685; A01D 34/74; A01D 34/78; A01D 34/81; A01D 34/82; A01D 101/00

(52) U.S. Cl. CPC A01D 34/69; A01D 34/685; A01D 34/74; A01D 34/78; A01D 34/81; A01D 34/824; A01D 2101/00

(57) ABSTRACT

A walk-behind outdoor power machine includes a chassis; a handle assembly pivotally connected to the chassis; spaced-apart first and second rear wheels connected to the chassis, each of the first and second rear wheels being coupled to a drive hub; spaced-apart first and second front wheels connected to the chassis; an electrical power pack configured to supply electric energy to the drive hub; a deck assembly mounted to the chassis, the deck assembly including: a deck defining an open-bottomed housing, including a top panel and a peripheral wall structure; at least one blade motor mounted to the top panel of the deck; and at least one blade rotatably mounted to the blade motor.

### CROSS REFERENCE TO RELATED APPLICATIONS

The present application is a Continuation Application of PCT Application No. PCT/CN2022/119232 filed on Sep. 16, 2022, the contents of which are incorporated herein by reference in their entirety.

### BACKGROUND OF THE INVENTION

This invention relates generally to outdoor power equipment, and more particularly to self-propelled walk-behind outdoor power machines.

Various types of outdoor power machines are known. Examples of common machines include lawn mowers and lawn tractors. Some outdoor power machines have an operator seat and are considered “ride-on”, “riders”, or “riding” machines. Others require an operator to walk behind and/or push the outdoor power machine.

Some known outdoor power machines are battery powered. They include a battery pack which provides electrical power for the primary operating components of the machine, such as the drive wheels and mower deck. The battery pack also provides electrical power for controls, displays, and accessories of the machine.

Despite the technology available in the prior art, there remains a need for outdoor power machines, especially walk-behind mowers, having improved performance in the areas of cutting, drive flexibility, and controls.

### BRIEF SUMMARY OF THE INVENTION

This need is addressed by a walk-behind outdoor power machine that allows a user to move in a forward direction and reverse direction as well as control many aspects of the machine performance.

According to one aspect of the invention, a walk-behind outdoor power machine includes a chassis; a handle assembly pivotally connected to the chassis; spaced-apart first and second rear wheels connected to the chassis, each of the first and second rear wheels being coupled to a drive hub; spaced-apart first and second front wheels connected to the chassis; an electrical power pack configured to supply electric energy to the drive hub; a deck assembly mounted to the chassis, the deck assembly including: a deck defining an open-bottomed housing, including a top panel and a peripheral wall structure; at least one blade motor mounted to the top panel of the deck; and at least one blade rotatably mounted to the blade motor.

According to another aspect of the invention, a walk-behind outdoor power machine includes a chassis; a handle assembly pivotally connected to the chassis; spaced-apart first and second rear wheels connected to the chassis, each of the first and second rear wheels being coupled to a drive hub; spaced-apart first and second front wheels connected to the chassis; an electrical power pack configured to supply electric energy to the drive hub; a deck assembly mounted to the chassis, the deck assembly including: a deck defining an open-bottomed housing, including a top panel and a peripheral wall structure; first and second blade motors mounted to the top panel of the deck; and a first blade rotatably mounted to the first blade motor and a second blade rotatably mounted to the second blade motor.

### BRIEF DESCRIPTION OF THE DRAWINGS

The invention may be best understood by reference to the following description taken in conjunction with the accompanying drawing figures in which:

FIG. 1 is a perspective view of a walk-behind outdoor power machine;

FIG. 2 is a perspective view of the machine of FIG. 1;

FIG. 3 is a top view of the machine of FIG. 1;

FIG. 4 is a top view of the machine of FIG. 1, with certain parts removed;

FIG. 5 is a bottom view of the machine of FIG. 1;

FIG. 6 is a perspective view of a chassis of the machine of FIG. 1;

FIG. 7 is a perspective view of a deck lift of the machine of FIG. 1;

FIG. 8 is a perspective view of the deck lift of FIG. 7;

FIG. 9 shows a control panel of the machine of FIG. 1;

FIG. 10 is a perspective view of a control housing of the machine of FIG. 1;

FIG. 11 is a top view of the control housing of FIG. 10;

FIG. 12 is a top view of the control housing of FIG. 10, with certain parts removed; and

FIG. 13 is a side view of the machine of FIG. 1 in a storage position.

### DETAILED DESCRIPTION

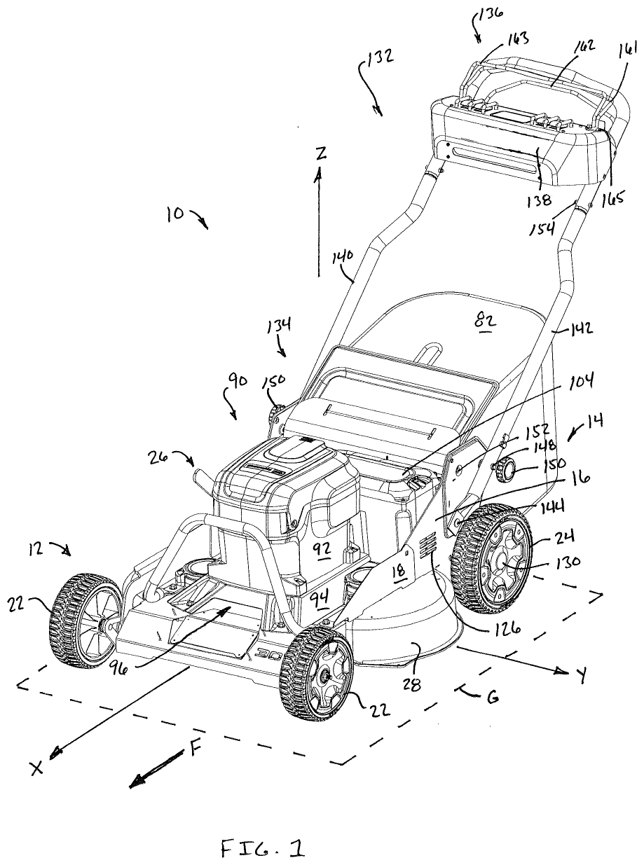

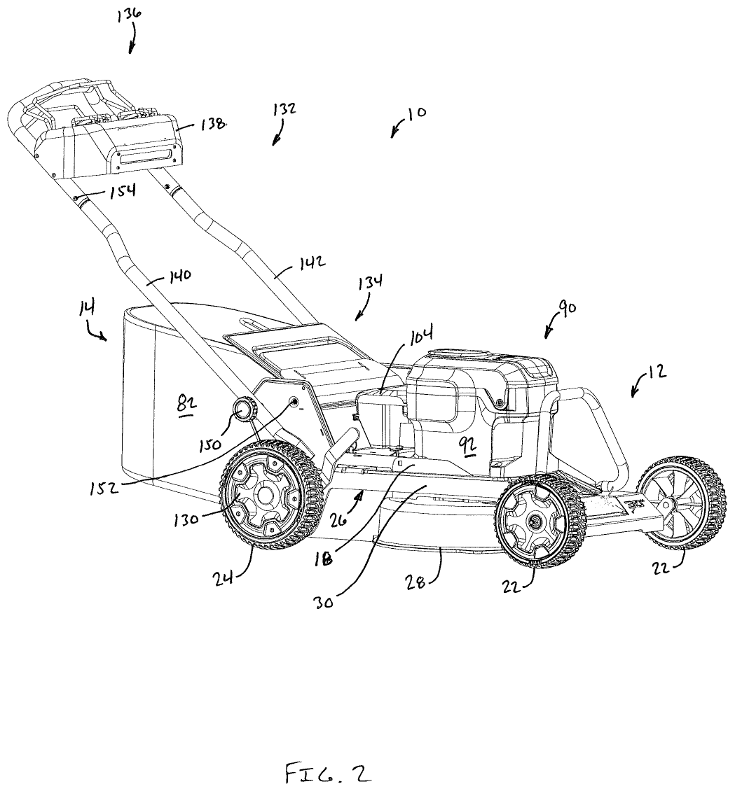

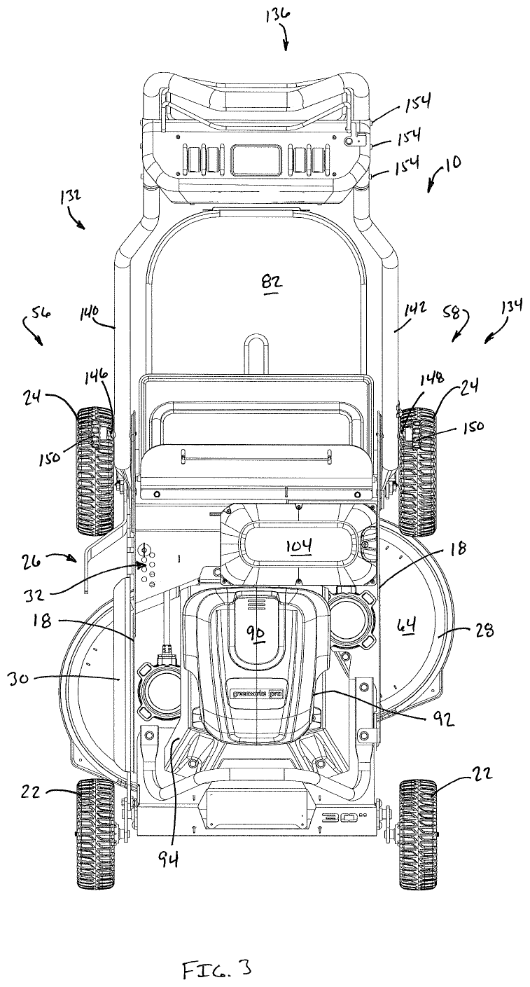

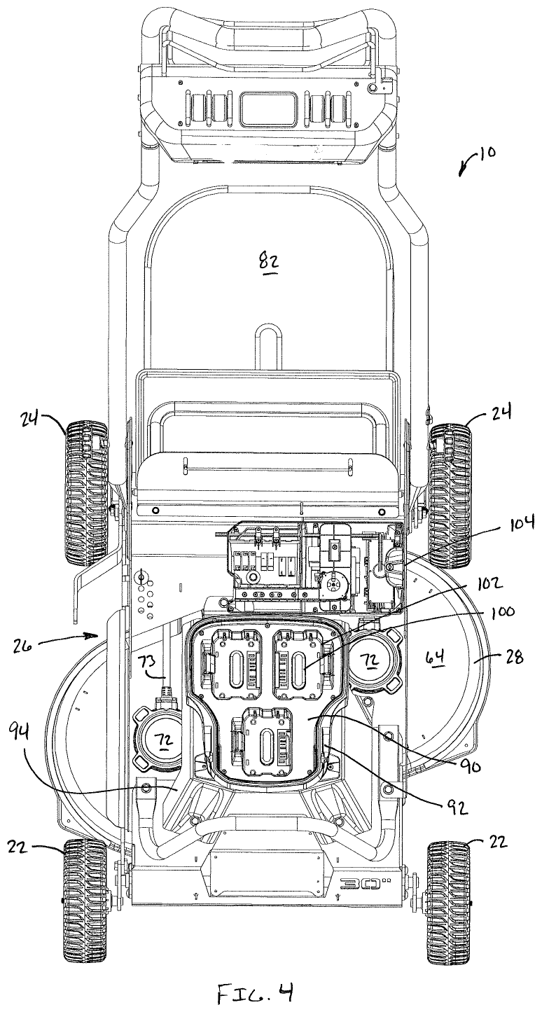

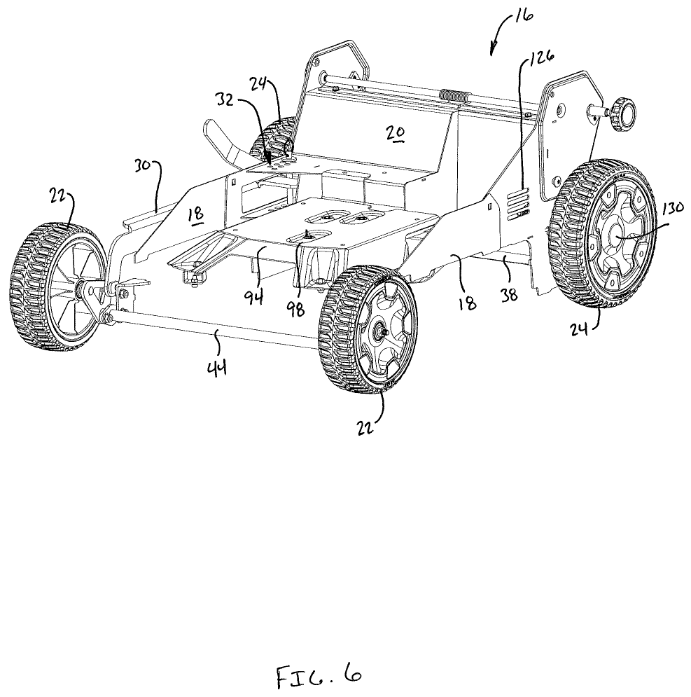

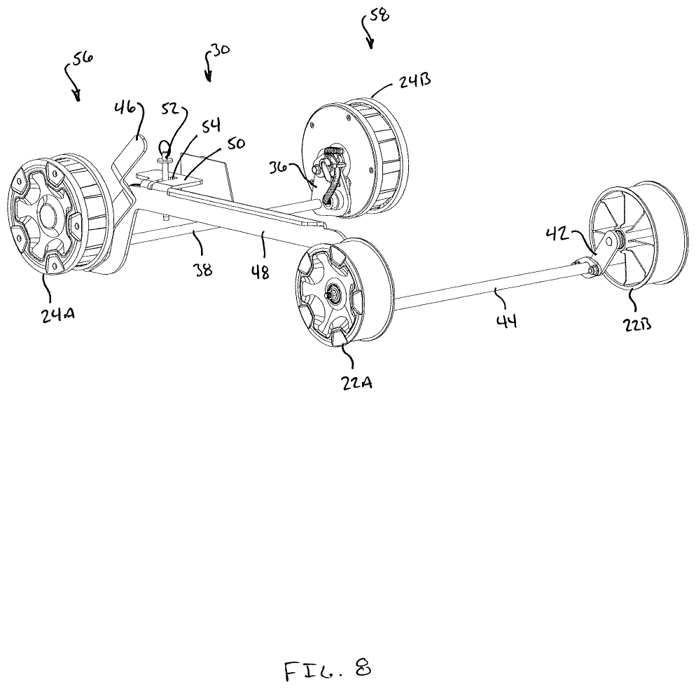

Referring to the drawings wherein identical reference numerals denote the same elements throughout the various views, FIGS. 1-8 show a representative embodiment of a walk-behind outdoor power machine 10. The machine 10 extends along an axial direction (arrow “X”) between a front end 12 and a rear end 14. The points of contact of the wheels of the machine 10 collectively define a ground plane “G”.

It is noted that, as used herein, the terms “axial” and “longitudinal” both refer to a direction parallel to the axis X, while “vertical” refers to a direction perpendicular to the axial direction and to the ground plane G (see arrow “Z” in FIG. 1) and “lateral” refers to a direction mutually perpendicular to the axial and vertical directions (see arrow “Y” in FIG. 1). A primary forward direction of ground travel is shown by the arrow “F” in FIG. 1. These directional terms are used merely for convenience in description and do not require a particular orientation of the structures described thereby.

In the illustrated example, the outdoor power machine 10 is a self-propelled walk-behind mower. The machine 10 has a chassis 16 which provides structural support as well as mounting locations for the various components of the machine 10. Any material with adequate structural strength may be used to construct the chassis 16. Examples of suitable materials include metals such as aluminum and steel and their alloys. The chassis 16 may be monolithic or may be built up from smaller components, e.g., via fasteners, adhesives, or welding.

The chassis 16 includes a pair of spaced-apart main frame rails 18 extending in a longitudinal direction from the front end 12 of the machine 10 to the rear end 14 of the machine 10. Cross member 20 interconnects the main frame rails 18 at the rear end 14 of the machine 10.

The chassis 16 is supported by two front wheels 22 and two rear wheels 24. A height adjustment mechanism 26 is provided which moves the wheels 22, 24 to raise and lower the chassis 16 a preselected distance above the ground plane G; thus, raising and lowering deck 28 and determining a grass mowing height. Typical examples include a mowing height in the range of approximately 1 inch to approximately 6 inches.

The height adjustment mechanism 26 connects the front wheels 22 and rear wheels 24 to the chassis 16 and includes a lift assembly 30 and a height adjuster 32. The lift assembly 30 includes a first lift crank 34 connected to the right rear wheel 24A, a second lift crank 36 connected to the left rear wheel 24B, a first tie rod 38 interconnecting the first lift crank 34 and second lift crank 36, a third lift crank 40 connected to the right front wheel 22A, a fourth lift crank 42 connected to the left front wheel 22B, and a second tie rod 44 interconnecting the third lift crank 40 and fourth lift crank 42.

The first lift crank 34 includes a lift handle 46 to allow a user to manually operate the lift assembly 30. Linkage 48 is connected between the first lift crank 34 and the third lift crank 40 such that movement of the lift handle 46 causes the first and third lift cranks 34, 40 to rotate. This in turn causes the second lift crank 36 to rotate via the first tie rod 38 and the fourth lift crank 42 to rotate via the second tie rod 44.

A blade member 50 is connected to the linkage 48 and interacts with height adjuster 32. More particularly, a pin 52 extends through an aperture 54 of the blade member 50 and into a selected aperture of the height adjuster 32, thereby locking the lift assembly 30 at a preselected height.

As the height adjustment mechanism 26 is moved to lower the chassis 16, the front and rear wheels 22, 24 move inwardly towards a center of the chassis 16, thereby shortening the machine's 10 wheelbase. As the height adjustment mechanism 26 is moved to raise the chassis 16, the front and rear wheels 22, 24 move outwardly from the center of the chassis 16, thereby lengthening the machine's 10 wheelbase. While the height adjustment mechanism 26 is described with the linkage 48 and lift handle 46 being located on a right side 56 of the machine 10, it should be appreciated that height adjustment mechanism 26 may be reversed so that the linkage 48 and lift handle 46 are located on the left side 58 of the machine 10.

A deck 28 is mounted to the chassis 16. The deck 28 has an overall width “W” between left and right sides 58, 56 which may be selected to provide a desired cutting swath. It will be understood that the overall width W is a nominal designated size and does not necessarily describe a precise dimension. In general, the deck configuration described herein is especially useful for decks of at least approximately 30 inches. Non-limiting examples of suitable deck widths include 32 inches, 34 inches, or 36 inches.

One or more mowing blades (designated 62 generally) are rotatably mounted on the underside of the top panel 64. Each mowing blade 62 generally includes two or more tips 66, each incorporating a cutting edge 68 and a fin 70 intended to produce a suction effect in operation. In operation, each mowing blade 62 will cut a swath of grass or other plant material equal to its diameter “D” measured between the tips 66. Numerous detail designs of mowing blades are known, and it will be understood that the deck 28 could also be used with blade shapes other than those illustrated, or with articulated blades or with flail cutting devices.

The mowing blades 62 are positioned in a spaced-apart configuration such that their tips 66 will not collide in operation. The mowing blades 62 may be positioned to have some overlap in their cutting swaths so as to prevent un-mowed strips of grass when mowing. The dimensions of the individual mowing blades 62 are selected to provide adequate structural strength at selected operating speed, (e.g. 3600 RPM). Generally, the diameter of each individual mowing blade 62 can be equal to the deck width W divided by the number of mowing blades 62, with some additional diameter provided to accommodate for swath overlap. For example, a deck 28 having a nominal width of 30 inches could use two mowing blades 62 each having a diameter of approximately 15.5 inches.

In the illustrated example, there is a left mowing blade 62A and a right mowing blade 62B. The left mowing blade 62A is mounted slightly to the rear of the right mowing blade 62B in a fore-aft direction. The mowing blades 62 are positioned such that they have a slight overlap of their cutting swaths in the left-right direction.

Means are provided for driving the mowing blades 62. Nonlimiting examples of suitable drive methods include mechanical, hydraulic, or electrical devices. In the illustrated example, each mowing blade 62 is directly driven by its own individual electric blade motor 72. In the illustrated example, each blade motor 72 is a DC brushless motor, for example, 82V motors with a rated output of approximately 1.8 kw. Other suitable outputs may be used.

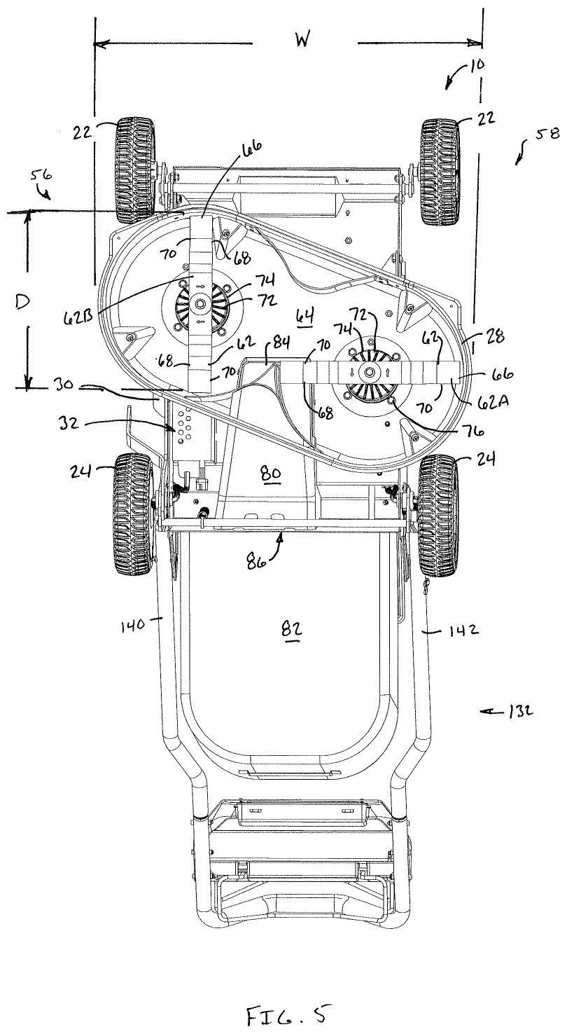

Each blade motor 72 fits through an individual motor opening 74 in the top panel 64. The blade motor 72 is retained in position using threaded fasteners 76. The two electric blade motors 72 drive and/or rotate the mowing blades 62 inwardly. In other words, looking from the bottom (FIG. 5), the left mowing blade 62A rotates counter-clockwise and the right mowing blade 62B rotates clockwise. Such rotation aids in pushing clippings into discharge chute 80 which is positioned central to the left and right mowing blades 62A, 62B and exits out a rear end 14 of the machine 10 into a bag assembly 82 removably attached to the rear end 14 of the machine. A plug 84 may be inserted into the discharge chute 80 to allow the deck 28 to perform a mulching operation.

As illustrated in FIG. 5, the discharge chute 80 is angled towards the right side 56 of the machine 10 to discharge clippings into the bag assembly 82 at an angle to aid in filling the bag assembly 82 more efficiently. In other words, by discharging the clippings at an angle relative to the axial direction X towards a right side 56 of the machine, the clippings are forced into the rear corners of the bag assembly 82 instead of loading up at the discharge chute exit 86.

The machine 10 is equipped with an electric power pack 90 suitable for storing and discharging electrical energy. In the illustrated example, the electric power pack 90 includes at least one storage battery including one or more chemical cells, for example lithium ion cells. Other liquid battery chemistries may be substituted, as well as solid state batteries, capacitors, or similar devices which may exist currently or be later developed. The electric power pack 90 may include ancillary electrical components such as transformers, voltage converters, relays, circuit breakers, and/or sensors.

As illustrated, the electric power pack 90 includes a housing 92 mounted to a raised platform 94. As illustrated, the housing 92 includes three receptacles 102 for housing three storage batteries. The platform 94 is connected to the chassis 16 and creates a space 96 between the electric power pack 90 and the deck 28 to allow for airflow and moisture removal from the housing 92. As shown, the platform 94 includes drainage holes 98 that interact with drainage holes 100 in the housing 92 to allow moisture to drain from the housing 92.

The electric power pack 90 is positioned such that at least one of the storage batteries is positioned forward of a center of the machine 10 in the axial direction X such that the electric power pack 90 adds weight to the front wheels 22 to prevent the front wheels 22 from being lifted off of the ground plane G when mowing up a slope or when grass clippings in the bag assembly 82 add weight to the rear end 14 of the machine 10.

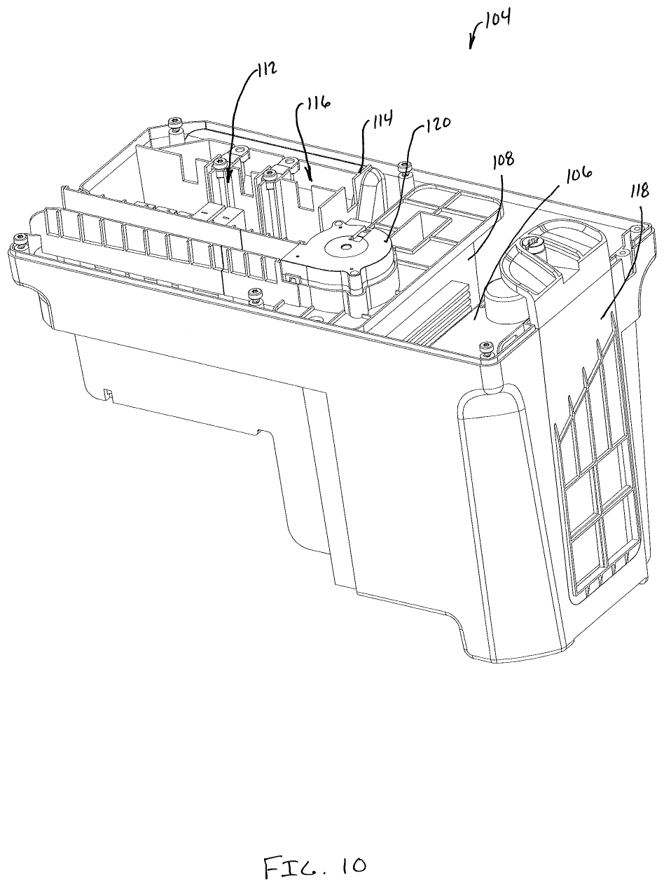

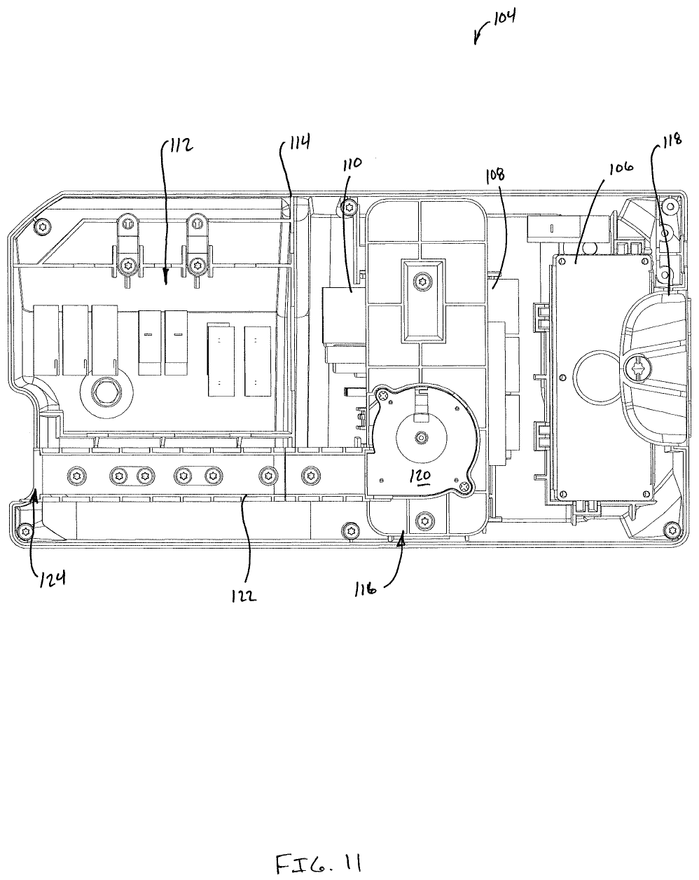

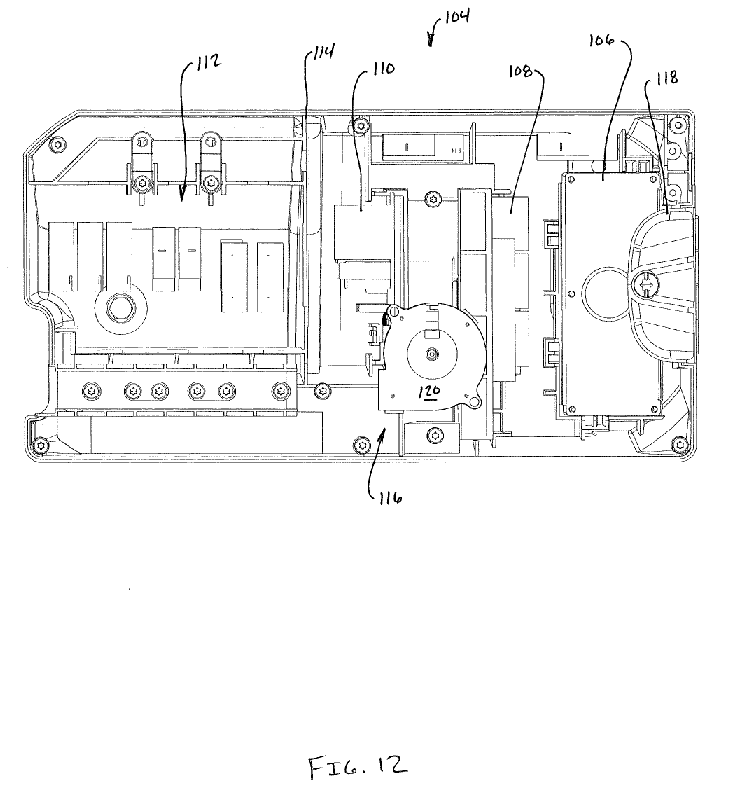

A separate control housing 104 is disposed above the deck 28 behind the housing 92. The control housing 104 includes one or more electronic controllers for receiving electric power from the storage batteries and supplying it to the electrical components of the machine 10. More particularly, as shown in FIGS. 10-12, the control housing 104 includes a drive hub controller 106, a battery logic controller 108, a blade motor controller 110, and electrical connectors 112 to interconnect the electric power pack 90 and the controllers 106, 108, 110 and distribute power to the various components of the machine 10. A partition 114 separates the electrical connectors 112 from the controllers 106, 108, 110 to prevent heat swings from affecting the electrical connectors 112.

The control housing 104 includes a cooling system 116 for maintaining temperatures within the control housing below a threshold temperature. The cooling 116 includes an air filter 118, a circulation fan (not shown) positioned below the battery logic controller 108, an exhaust fan 120, and an exhaust rail 122 cooperating with the exhaust fan 120 to exhaust hot air out exit 124 of the control housing 104. In operation, air is sucked into the control housing 104 through openings 126 in chassis 16 (FIG. 1). Prior to entering the control housing 104, air filter 118 filters the air to remove dust and other pollutants. The filtered air is circulated through the control housing 104 to cool the electronics therein and then exhausted through exit 124 by exhaust fan 120.

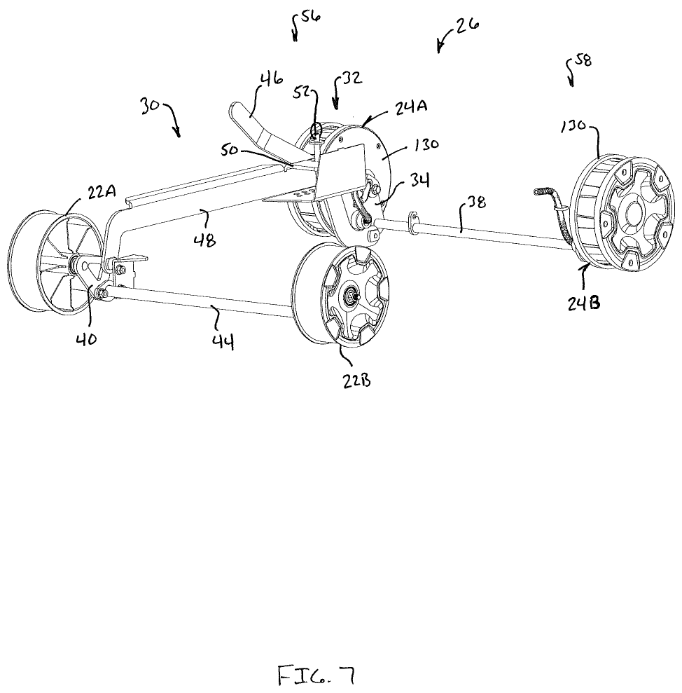

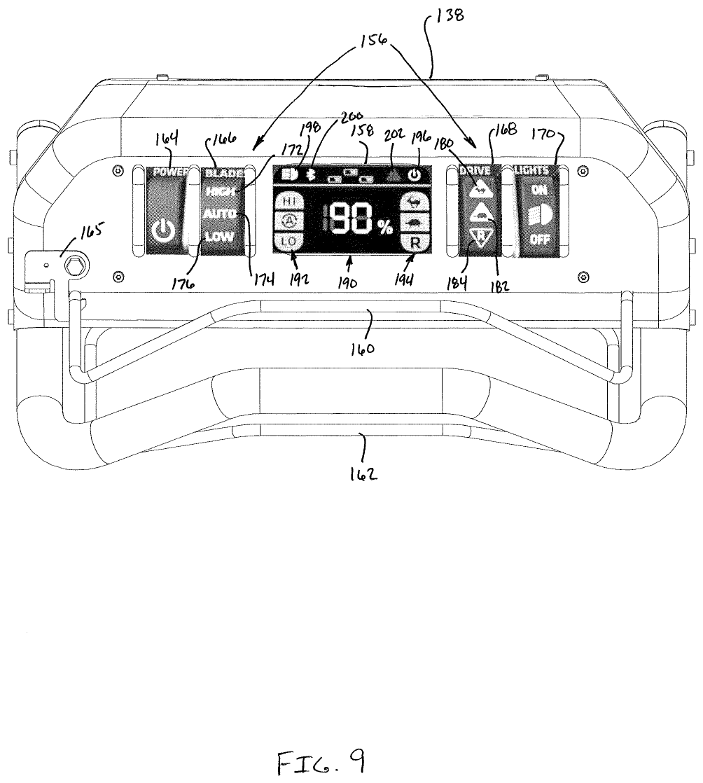

The drive hub controller 106 controls each of the drive hubs 130 (FIG. 7). The drive hub controller 106 is electrically connected to the electric power pack 90 as well as to operator controls (FIG. 9) as described below to drive the machine 10 in both a forward direction and a rearward direction as well as control a speed of the machine 10. Additionally, the drive hub controller 106 may be responsive to sensor inputs from sensors such as an inclinometer to increase the speed of one drive hub 130 relative to the speed of the other drive hub 130 to maintain the machine 10 on a desired path when on an incline.

As illustrated, each of the rear wheels 24 is driven by its own drive hub 130; however, it should be appreciated that the front wheels 22 may also be driven by individual drive hubs as well. Each drive hub 130 may include an internal electric motor, a gear reduction drive, and an optional brake (not separately illustrated). A ground engaging surface such as a rubber tire wraps around the drive hub 130 to form the rear wheels 24. The drive hubs 130 are configured to be driven independently at the same speed or a different speed as desired to provide different effects such as turning the machine 10 and/or stabilizing the machine 10 when operated on sloped ground. The drive hubs 130 can also be driven backwards.

The battery logic controller 108 controls power distribution for the machine 10. For example, the battery logic controller 108 may distribute different voltages to various components to make sure the machine 10 is operating efficiently. The battery logic controller 108 may also link the storage batteries together and control how much voltage is pulled from each storage battery. In other words, the battery logic controller 108 may pull different voltages from each of the storage batteries based on power needs, battery charge levels, etc. and combine the voltages for use by the machine 10.

The blade motor controller 110 has a high voltage (e.g. 82V) electrical connection to the electric power pack 90. It also includes electrical connections to operator controls, such as a blade start-stop switch or speed control switch. These control connections may operate at a lower voltage (e.g. 5 v or 12 v). The blade motor controller 110 is electrically connected to the individual blade motors 72 by blade motor cables 73 which connect to the blade motors 72. Each blade motor cable 73 may include one or more conductors carrying DC currents to operate the blade motor 72, as well as one or more conductors carrying low voltage signals, such as motor speed feedback signals.

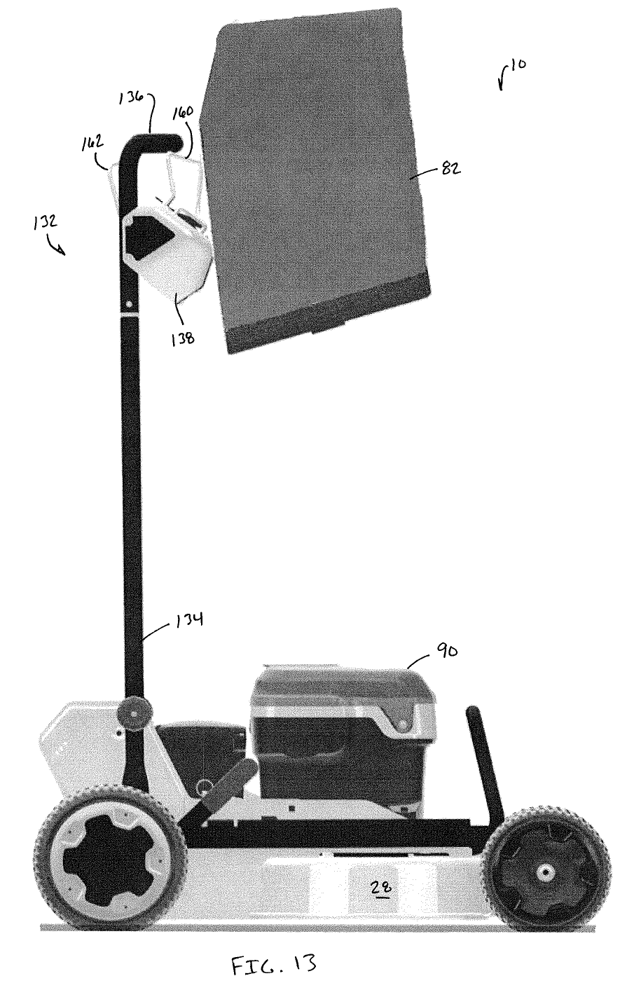

A handle assembly 132 has a lower end 134 pivotally connected to the chassis 16 and an upper end 136 carrying a control panel 138. The handle assembly 132 is moveable between a use position, FIG. 1, and a storage position, FIG. 13. As illustrated, the lower end 134 of the handle assembly 132 includes a first member 140 pivotally connected to the right side 56 of the chassis 16 and a second member 142 pivotally connected to the left side 58 of the chassis 16 by pins 144. The lower end 134 of the handle assembly is made of a structural material such as aluminum, steel or other suitable materials. First and second spring-loaded pins 146, 148 allow a user to secure the handle assembly 132 in either the use position or the storage position. Each of the pins 146, 148 include a knob and/or handle 150 to allow a user to easily pull the pins 146, 148 outwardly to release the pins 146, 148 from apertures 152 in chassis 16, thereby allowing movement of the handle assembly 132 between the use and storage positions. Releasing of the handle 150 allows the pins 146, 148 to re-engage the apertures 152 in the chassis 16 to lock the handle assembly 132 in either the use or storage position.

The control panel 138 is positioned between and secured to the first and second members 140, 142. The control panel may be structural and provide additional stiffness to the handle assembly 132. As shown, the upper end 136 of the handle assembly 132 is formed of an insulating material such as plastic or any other suitable material to prevent electrical shock. The upper end 136 is slid over the first and second members 140, 142 and connected thereto by fasteners 154.

Referring to FIG. 9, the control panel 138 includes switchgear 156, a user interface 158, a blade selector 160, and a hub drive lever 162 as required to control functions of the machine 10. The switchgear 156 includes a power switch 164, a blade switch 166, a drive switch 168, and a light switch 170. The power switch 164 turns the machine 10 on and off and the light switch 170 turns lights on and off.

The blade switch 166 includes three settings: High 172, Auto 174, and Low 176. The High setting 172 provides maximum power for high grass and/or high loads. The Auto setting 174 allows the blades 62 to be rotated at a speed dependent on the load being sensed by the machine 10. In other words, it provides a variable speed for the blades 62. For example, if bagging leaves, the load would be low and the rotational speed of the blades 62 would be reduced to help lift the leaves into the bag assembly 82; however, if mowing tall grass, the load would be high and the rotational speed of the blades 62 would be increased to meet the demand of the additional load. For example, the blade speed may be raised from 3600 rpm to 4000 rpm. The Low setting 176 is a battery saving mode. Depending on the setting chosen, user interface 158 will send a signal to the blade motor controller 110 which will then adjust blade rotational speed accordingly.

The blade selector 160 is moveable between a use position 161 and a non-use position 163 (FIG. 1). In the use position 161, the blades 62 are engaged and rotate to cut. In the non-use position 163, the blades are prevented from rotating; thus, the machine 10 may be on and driven forward or in reverse without the blades rotating. A lockout 165 prevents the blade selector 160 from being moved to the use position 161 accidentally by requiring the user to positively unlock the blade selector 160 first. As shown in FIG. 13, when the handle assembly 132 is in the storage position, the blade selector 160 may also be used to hang the bag assembly 82 thereon.

The drive switch 168 also includes three settings: rabbit and/or fast 180, turtle and/or slow 182, and reverse 184. In the fast setting 180, the user can reach maximum forward speed of the machine 10 by pulling the hub drive lever 162 to its maximum position. It should be understood that the hub drive lever 162 allows for a variable speed by pulling the hub drive lever 162 to different positions. In the fast setting 180, the hub drive lever 162 allows for a variable speed between 0 and 6 mph. In the slow setting 182, the forward speed of the machine 10 is limited to a speed less than the maximum forward speed. For example, in the slow setting 182, the hub drive lever 162 allows for a variable speed between 0 and 3 mph. By moving the drive switch 168 to the reverse setting 184, a user can move the machine 10 in a reverse direction. This is helpful when dealing with slopes or loading the machine 10 onto a trailer. The reverse setting 184 limits the variable speed to prevent a user from being run over by the machine 10. For example, in the reverse setting 184, the variable speed may be between 0 and 2 mph.

When in the reverse setting 184 additional safety precautions may be implemented. For example, an audible alarm such as beeping may be deployed to alert a user that the reverse setting 184 has been engaged. Further, the reverse setting 184 locks out the blades 62 and prevents them from rotating during the reverse operation.

The user interface 158 provides a user with important information via a visual indication. For example, the user interface 158 provides a user with visual indications for: battery charge level 190, blade setting 192, drive setting 194, power on/off 196, lights on/off 198, Bluetooth connection 200, and error or malfunction 202.

The machine 10 may also include a transceiver or communication device (not illustrated) interconnected with the control systems of the machine 10 and using a wireless network protocol such as 4G to provide functions such as over the air software or data updates, allow user defined settings to be implemented, lock out the machine 10, locate the machine 10, and/or receive and send alerts.

The foregoing has described a walk-behind outdoor power machine. All of the features disclosed in this specification, and/or all of the steps of any method or process so disclosed, may be combined in any combination, except combinations where at least some of such features and/or steps are mutually exclusive. Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A walk-behind outdoor power machine, comprising:
a chassis;
a handle assembly pivotally connected to the chassis;
spaced-apart first and second rear wheels connected to the chassis, each of the first and second rear wheels being coupled to a drive hub;
spaced-apart first and second front wheels connected to the chassis;
an electrical power pack configured to supply electric energy to the drive hub;
a deck assembly mounted to the chassis, the deck assembly including:
a deck defining an open-bottomed housing, including a top panel and a peripheral wall structure;
at least one blade motor mounted to the top panel of the deck; and
at least one blade rotatably mounted to the blade motor.

2. The machine of claim 1, further including a height adjustment mechanism, the height adjustment mechanism being configured to raise and lower the chassis.

3. The machine of claim 2, wherein the height adjustment mechanism connects the first and second rear wheels and first and second front wheels to the chassis.

4. The machine of claim 2, wherein the height adjustment mechanism includes a lift assembly, the lift assembly moving the first and second rear wheels and first and second front wheels at the same time to raise and lower the chassis.

5. The machine of claim 4, wherein the lift assembly includes:
a first lift crank connected to the first rear wheel;
a second lift crank connected to the second rear wheel;
a first tie rod interconnecting the first and second lift cranks;
a third lift crank connected to the first front wheel;
a fourth lift crank connected to the second front wheel;
a second tie rod interconnecting the third and fourth lift cranks;
a linkage interconnecting the first lift crank and the third lift crank; and
a lift handle connected to the linkage to manually operate the lift assembly.

6. The machine of claim 1, wherein the drive hubs for the first and second rear wheels rotate in two directions to move the machine in a forward direction and in a reverse direction.

7. The machine of claim 6, wherein in the reverse direction, the at least one blade is locked out from rotation.

8. The machine of claim 1, wherein the first and second wheels rotate at different speeds in response to a sensor input indicating the machine is on a slope.

9. A walk-behind outdoor power machine, comprising:
a chassis;
a handle assembly pivotally connected to the chassis;
spaced-apart first and second rear wheels connected to the chassis, each of the first and second rear wheels being coupled to a drive hub;
spaced-apart first and second front wheels connected to the chassis;
an electrical power pack configured to supply electric energy to the drive hub;
a deck assembly mounted to the chassis, the deck assembly including:
a deck defining an open-bottomed housing, including a top panel and a peripheral wall structure;
first and second blade motors mounted to the top panel of the deck; and
a first blade rotatably mounted to the first blade motor and a second blade rotatably mounted to the second blade motor.

10. The machine of claim 9, wherein the blade is positioned slightly to a rear of the second blade.

11. The machine of claim 9, further including a discharge chute extending outwardly from a rear of the deck.

12. The machine of claim 11, wherein the discharge chute is angled towards a side of the machine.

13. The machine of claim 9, further including a bag assembly connected to a rear of the machine and operably connected to the deck to receive debris from the deck.

14. The machine of claim 9, further including a controller housing separate from the electrical power pack.

15. The machine of claim 14, wherein the controller housing includes one or more electronic controllers for receiving electric power from the electric power pack.

16. The machine of claim 14, wherein the controller housing includes a drive hub controller, a battery logic controller, a blade motor controller, and electrical connectors.

17. The machine of claim 9, further including a platform connected to the chassis, the platform raising the electrical power pack above the deck such that a space extends therebetween.

18. The machine of claim 9, further including a control panel secured to the handle assembly, the control panel including switchgear, a user interface, a blade selector, and a hub drive lever to control functions of the machine.

19. The machine of claim 9, further including a control panel secured to the handle assembly, the control panel including a blade switch, the blade switch having a high setting, an auto setting, and a low setting to control a speed of the first and second blades.

20. The machine of claim 9, further including a control panel secured to the handle assembly, the control panel including a drive switch, the drive switch having a fast forward direction setting, a slow forward direction setting, and a reverse direction setting.
